(19) United States
(12) Patent Application Publication
(10) Pub. No.: US 2020/0073465 A1
(43) Pub. Date: Mar. 5, 2020

(54) LOAD REDUCTION IN A VISUAL RENDERING SYSTEM

(71) Applicant: QUALCOMM Incorporated, San Diego, CA (US)

(72) Inventors: Soman Ganesh Nikhara, Hyderabad (IN); Bapineedu Chowdary Gummadi, Hyderabad (IN); Pradeep Veeramalla, Hyderabad (IN); Ravi Shankar Kadambala, Hyderabad (IN); Ankita Anil Kumar Choudha, Hyderabad (IN)

(21) Appl. No.: 16/118,214

(22) Filed: Aug. 30, 2018

(51) Int. Cl. G06F 1/32; G06F 3/01

(52) U.S. Cl. CPC G06F 1/3265; G06F 1/324; G06F 1/3206; G06F 3/013

(57) ABSTRACT

In one implementation, an electronic visual-rendering device includes an eye-tracking sensor and at least a first component. The eye-tracking sensor is configured to detect an eye-close event and, in response, output an eye-close-event message. The first component is configured to operate in at least a normal-power mode and a first low-power mode. The first components is configured to transition from operating in the normal-power mode to operating in the first low-power mode in response to the eye-tracking sensor's output of the eye-close-event message.

### BACKGROUND

Some types of visually rendered media, such as immersive videos, virtual reality (VR) programs, and augmented reality (AR) programs, are typically presented to a viewing user via a head-mounted display (HMD). Head-mounted displays include helmet-mounted displays (e.g., Jedeye, a registered trademark of Elbit Systems, Ltd., of Haifa, Israel), headset goggle displays (e.g., Oculus Rift, a registered trademark of Oculus VR, LLC of Menlo Park Calif.), smart glasses, also known as optical head-mounted displays (e.g., Glass, a registered trademark of Google LLC of Mountain View, Calif.), and mobile-device-supporting head mounts (e.g., Google Cardboard, a registered trademark of Google LLC) that include a smartphone. A head-mounted display may be a wireless battery-powered device or a wired wire-powered device.

A typical head-mounted VR device comprises a computer system and requires consistently intensive computation by the computer system. The computer system generates dynamic images that may be in high definition and refreshed at a high frame rate (e.g., 120 frames per second (fps)). The dynamic images may be completely internally generated or may integrate generated images with image input from, for example, a device-mounted camera, or other source. The computer system may process inputs from one or more sensors that provide information about the position, orientation, and movement of the visual-rendering device to correspondingly modify the rendered image. The position, orientation, and movement of the rendered visual image is modified to correspond, in real time, to the position, orientation, and movement of the visual-rendering device. Additionally, the computer system may perform one or more rendered-image modifications to correct for display distortions (e.g., barrel distortion). Furthermore, at least some of the modifications may be different for the left and right eyes of the user.

The computer system may include one or more processing units, such as central processing units (CPUs) and graphics processing unit (GPUs), to perform the above-described processing operations. These computationally intensive operations contribute significantly to heat-generation within the processing units and the computer system, as well as to power consumption by the computer system. Excessive heat may trigger thermal-mitigation operations, such as throttling the processing units, which reduces the performance of the VR device and degrades the user's experience. Systems and methods that reduce the computational load on the computer system would be useful for reducing the temperature of the processing units and avoiding thermal-mitigation throttling of the processing units. In addition, for battery-powered visual-rendering devices, such as smart glasses and mobile devices in mobile-device-supporting head mounts, the reduced load would reduce the power consumed and, consequently, extend the time until a battery recharge or replacement is required.

### SUMMARY

The following presents a simplified summary of one or more embodiments to provide a basic understanding of such embodiments. This summary is not an extensive overview of all contemplated embodiments, and is not intended to either identify key critical elements of all embodiments or delineate the scope of all embodiments. The summary's sole purpose is to present some concepts of one or more embodiments in a simplified form as a prelude to the more detailed description that is presented later.

In one embodiment, an electronic visual-rendering device comprises an eye-tracking sensor and a first component. The eye-tracking sensor is configured to detect an eye-close event and, in response, output an eye-close-event message. The first component is configured to operate in at least a normal-power mode and a first low-power mode. The first component is configured to transition from operating in the normal-power mode to operating in the first low-power mode in response to the eye-tracking sensor's output of the eye-close-event message.

In another embodiment, a method for an electronic visual-rendering device comprises detecting, by an eye-tracking sensor, an eye-close event, outputting, by the eye-tracking sensor, an eye-close-event message in response to the detecting of the eye-close event, operating a first component in a normal-power mode, and transitioning the first component from operating in the normal-power mode to operating in a first low-power mode in response to the eye-tracking sensor outputting the eye-close-event message.

In yet another embodiment, a system comprises means for electronic visual-rendering, means for detecting an eye-close event, means for outputting an eye-close-event message in response to detecting the eye-close event, means for operating a first component in a normal-power mode, and means for transitioning the first component from operating in the normal-power mode to operating in a first low-power mode in response to the outputting of the eye-close-event message.

### BRIEF DESCRIPTION OF THE DRAWINGS

The disclosed embodiments will hereinafter be described in conjunction with the appended drawings, provided to illustrate and not to limit the disclosed embodiments, wherein like designations denote like elements, and in which:

FIG. 1. is a simplified schematic diagram of a device in accordance with an embodiment of the disclosure.

FIG. 2 is a flowchart for a process for the operation of the device of FIG. 1 in accordance with one embodiment of the disclosure.

### DETAILED DESCRIPTION

Various embodiments are now described with reference to the drawings. In the following description, for purposes of explanation, specific details are set forth to provide a thorough understanding of one or more embodiments. It may be evident, however, that such embodiment(s) may be practiced without these specific details. Additionally, the term “component” as used herein may be one of the parts that make up a system, may be hardware, firmware, and/or software stored on a computer-read101le medium, and may be divided into other components.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples. Note that, for ease of reference and increased clarity, only one instance of multiple substantially identical elements may be individually labeled in the figures.

As used herein, the term “exemplary” means “serving as an example, instance, or illustration.” Any example described as “exemplary” is not necessarily to be construed as preferred or advantageous over other examples. Likewise, the term “examples” does not require that all examples include the discussed feature, advantage, or mode of operation. Use of the terms “in one example,” “an example,” “in one embodiment,” and/or “an embodiment” in this specification does not necessarily refer to the same embodiment and/or example. Furthermore, a particular feature and/or structure can be combined with one or more other features and/or structures. Moreover, at least a portion of the apparatus described hereby can be configured to perform at least a portion of a method described hereby.

It should be noted that the terms “connected,” “coupled,” and any variant thereof, mean any connection or coupling between elements, either direct or indirect, and can encompass a presence of an intermediate element between two elements that are “connected” or “coupled” together via the intermediate element. Coupling and connection between the elements can be physical, logical, or a combination thereof. Elements can be “connected” or “coupled” together, for example, by using one or more wires, cables, printed electrical connections, electromagnetic energy, and the like. The electromagnetic energy can have a wavelength at a radio frequency, a microwave frequency, a visible optical frequency, an invisible optical frequency, and the like, as practicable. These are several non-limiting and non-exhaustive examples.

A reference using a designation such as “first,” “second,” and so forth does not limit either the quantity or the order of those elements. Rather, these designations are used as a convenient method of distinguishing between two or more elements or instances of an element. Thus, a reference to first and second elements does not mean that only two elements can be employed, or that the first element must necessarily precede the second element. Also, unless stated otherwise, a set of elements can comprise one or more elements. In addition, terminology of the form “at least one of: A, B, or C” or “one or more of A, B, or C” or “at least one of the group consisting of A, B, and C” used in the description or the claims can be interpreted as “A or B or C or any combination of these elements.” For example, this terminology can include A, or B, or C, or (A and B), or (A and C), or (B and C), or (A and B and C), or 2A, or 2B, or 2C, and so on.

The terminology used herein is for the purpose of describing particular examples only and is not intended to be limiting. As used herein, the singular forms “a,” “an,” and “the” include the plural forms as well, unless the context clearly indicates otherwise. Further, the terms “comprises,” “comprising,” “includes,” and “including,” specify a presence of a feature, an integer, a step, a block, an operation, an element, a component, and the like, but do not necessarily preclude a presence or an addition of another feature, integer, step, block, operation, element, component, and the like.

In some embodiments of the disclosure, a visual-rendering device uses an eye-tracking sensor to detect when a user's eyes close—in other words, when a user blinks. In response to determining that a blink has started or is ongoing, the device reduces the power-level of one or more processing units for a duration corresponding to the blink, and then returns the one or more processing units to a normal power level. These intermittent power reductions help to keep the one or more processing units from overheating and to reduce power usage.

Although blinks have a very short, though variable, duration and occur at varying frequencies, their occurrences can provide useful power reductions. Typical blinks last between 100-300 ms and occur 5-30 times a minute. Both the duration and the frequency vary among users and over time for the same user. In addition, users can exhibit durations and frequencies outside the typical ranges. On average, one can expect a user's eyes to be closed for about 4 seconds out of every minute, providing a commensurate reduction in power—even considering the additional processing needed to detect blinking and perform the requisite processing to reduce and increase power levels.

A visual rendering device may have multiple components that may be beneficially operated at reduced power for the duration of a user's blinks. Such components include, for example, central processing units, graphics processing units, hardware accelerators, display controllers, memories, and displays. For some circuit, reduced-power operation may comprise, for example, operation at a reduced frequency, operation at a reduced voltage, and/or a power collapse. For some components, reduced-power operation may comprise processing fewer image frames by, for example, skipping or dropping frames. For some components, reduced-power operation may comprise reducing the frame resolution of processed image frames.

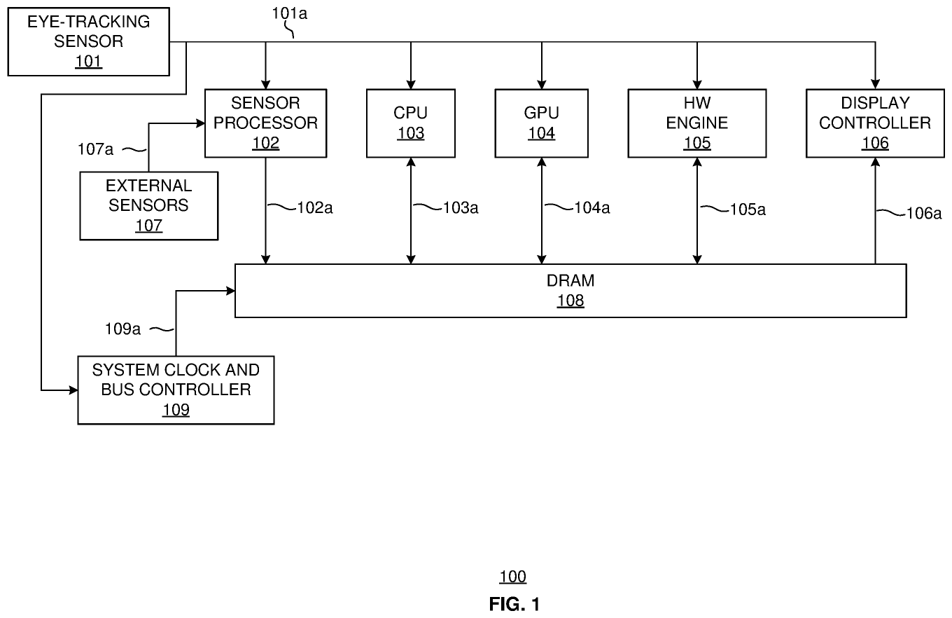

FIG. 1. is a simplified schematic diagram of a device 100 in accordance with an embodiment of the disclosure. The device 100 is a visual-rendering device that comprises an eye-tracking sensor 101, a sensor processor 102, a CPU 103, a GPU 104, a hardware (HW) engine 105, a display controller 106, external sensors 107, a dynamic RAM (DRAM) circuit 108, and system clock and bus controller 109. As described below, the device 100 may render visual images as part of generating VR, AR, or similar immersive video for a user.

The external sensors 107, which may include accelerometers, gyroscopes, and geomagnetic sensors, provide sensor data to the sensor processor 102 via path 107a. The sensor processor 102 uses the data from the external sensors 107 to calculate position and/or orientation information for the device 100, such as spatial location (x, y, z), pitch, yaw, and roll. The sensor processor 102 provides the position/orientation information to the CPU 103, which uses that information to generate and provide to the GPU 104 corresponding shape information that corresponds to the received position/orientation information and which may represent the outlines of one or more shapes to be rendered.

The GPU 104 uses the shape information to add texture to the shape outlines and generate visual-rendering information for the left and right eyes. Note that the left-eye and right-eye images should be slightly different for an immersive video to replicate the parallax effect of viewing using two eyes located a distance apart, which provides appropriate depth cues. The visual-rendering information is provided to the HW engine 105, which performs lens correction for the visual-rendering information by suitable modification of the visual-rendering information. The lens correction may be different for the left and right images. The corrected visual-rendering information is then provided to the display controller, which uses it to generate corresponding left and right images on the display (not shown) for the user to view.

In one implementation, data transmission between processing components of the device 100 may be accomplished by writing to and reading from the DRAM 108. This is illustrated by the connections to the DRAM 108 of the sensor processor 102, the CPU 103, the GPU 104, the HW engine 105, and the display controller 106, shown as respective paths 102a, 103a, 104a, 105a, and 106a. Specifically, a data-providing component writes its output to the DRAM 108 and that output is then read from the DRAM 108 by a corresponding data-receiving component. For example, the CPU 103 reads position/orientation information, which was written by the sensor processor 102, from the DRAM 108 and subsequently writes corresponding shape information to the DRAM 108, which will be subsequently read by the GPU 104.

The eye-tracking sensor 101 is a sensor that determines whether the user's eyes are closed or closing—in other words, whether an eye-close event has occurred. The eye-tracking sensor 101 may monitor both left and right eyes to determine whether both are closed/closing or it may monitor only one eye on the assumption that both eyes blink simultaneously. The eye-tracking sensor 101 may use any suitable sensor to determine whether an eye-close event has occurred. For example, the eye-tracking sensor 101 may use a light sensor, a near-light sensor, or a camera to determine whether the pupil, lens, iris, and/or any other part of the eye is visible. The eye-tracking sensor 101 may use a similar sensor to determine the eye-coverage state of the corresponding eyelid. The eye-tracking sensor 101 may use a motion sensor to detect muscle twitches and/or eyelid movement indicating a closing eyelid. The eye-tracking sensor 101 may use an electronic and/or magnetic sensor (e.g., an electromyographic sensor) detect muscle activity actuating eyelid closure or the corresponding neurological activity triggering the eyelid closure.

Upon a positive determination of eye closure by the eye-tracking sensor 101, the eye-tracking sensor 101 outputs an eye-close-event message via path 101a. The eye-close-event message may be broadcast to the sensor processor 102, the CPU 103, the GPU 104, the HW engine 105, the display controller 106, and the system clock and bus controller 109. The message may also other provided to other components (not shown) of the device 100. The message may be in any format suitable for the communication bus or fabric (not shown) of the device 100. In some implementations the message may be a broadcast interrupt. In some implementations, the message may be a corresponding signal ticking high or low or a signal pulse.

In response to receiving the eye-close-event message, the receiving component may enter a low-power mode. A low-power mode for any of the components may include applying one or more of the following power-reduction schemes to the entire component or part of the component. A component may reduce its supply voltage and/or operating clock frequency (e.g., using dynamic clock and voltage scaling (DCVS)). A component may use clock gating, which disables the clock to selected circuitry. A component may use power gating, which interrupts the power-to-ground path, to reduce leakage currents to near zero. A component that uses a cache may reduce its cache size. A component may reduce the data width or other data transfer rate parameter of its interface. A component may reduce its memory bandwidth. A component comprising multiple pipelines operating in parallel may reduce the number of active pipelines. A component may queue events in a buffer to delay their execution or processing. A component may vary any other suitable parameter to reduce power usage.

Particular components may employ additional types of processing power reduction schemes. Image-frame-processing components such as the CPU 103, the GPU 104, the HW engine 105, and the display controller 106 may reduce the processing power by, for example, dropping or skipping frames. The frame refresh rate may be reduced from, for example, 120 fps to, for example, 90, 60, or 30 fps. The image-frame-processing components may reduce the image resolution and/or color palette of the processed frames. The system clock and bus controller 109 may reduce the system clock frequency and/or voltage for the device 100 in general and the DRAM 108 in particular, e.g., via path 109a. The GPU 104 may also skip normal rendering operations such as layers blending. The sensor processor 102 may reduce its refresh rate for providing updated position and/or orientation information. One or more of the sensors 107 may enter a low-power mode or shut down.

Note that although the display itself (not shown) may be dimmed or turned off in response to the eye-close-event message, such diming or darkening of the screen may be visible to the user through closed eyelids, which may be disturbing and/or annoying. Consequently, the display may remain on, but rendering at a lower refresh rate and a lower resolution, in response to receiving an eye-close-event message.

Note that in some embodiments, the eye-tracking sensor 101 may control signal 101a to be high when the tracked eye is closed and to be low when the tracked eye is open, or vice-versa. Using the signal 101a, a component receiving the signal 101a may then set its power level accordingly in a manner suitable for the component.

Note that any particular component may have a plurality of low-power modes and the particular low-power mode entered in response to receiving the eye-close-event message may depend on any number of relevant parameters such as the instant thermal characteristics of the component and/or the device 100, instant work load of the component and/or other components of the device 100, and a battery power level of a battery (not shown) of the device 100.

The low-power mode may be in effect for a preset duration, such as 100 ms. A low-power-mode duration may be provided by the eye-tracking sensor 101 together with the eye-close-event message. The provided low-power-mode duration may be updated intermittently by determining when a corresponding eye-open event occurs, calculating the time difference between the eye-close event and the eye-open event. The low-power-mode duration is then set to be less than the calculated difference so that the visual rendering device will return to operating at normal power by the time the eye is predicted to be open again. Note that an eye-open event may be determined in any of the ways described above for determining an eye-close event or in any other suitable way. In other words, the eye-tracking sensor 101 may determine, depending on the particular implementation, that the eye is affirmatively open, the eye is not closed, or that a closed eyelid is opening or about to open.

In some alternative implementations, the eye-tracking sensor 101 broadcasts, via path 101a, an eye-open-event message that is used to wake up components of the device 100 from a low-power operation to a normal-power operation. Since the eye-tracking sensor 101 may detect an eye starting to open before it is fully open, the components of the device 100 may be back to normal-power operation by the time the eye is fully open so that the user does not see the low-power-operation visual rendering.

If the device 100 provides audio content in conjunction with the visual rendering, then the audio processing (not shown) may continue to operate at normal power—and, consequently, normal resolution, clarity, and volume—while the above-described components of the device 100 are operating at low power in response to the eye-close-event message. This is done since the user's audio experience is not affected by blinking and should continue unmodified by blinking.

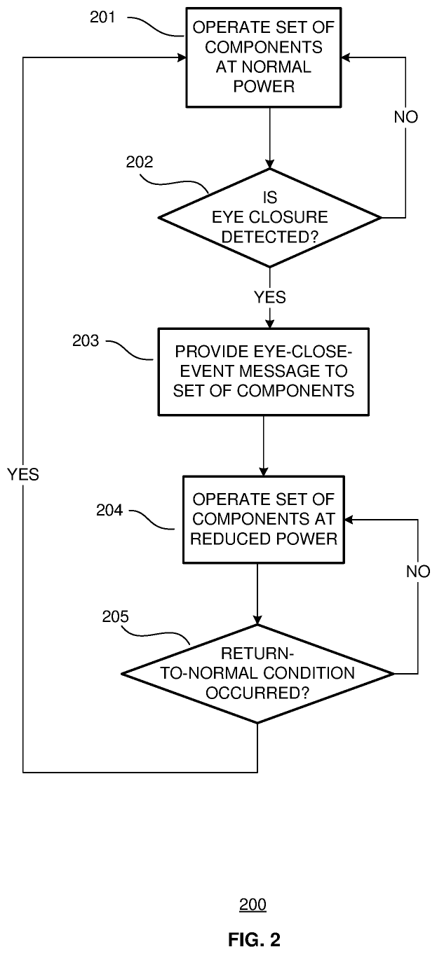

FIG. 2 is a flowchart for a process 200 for the operation of the device 100 of FIG. 1 in accordance with one embodiment of the disclosure. Process 200 starts with operating a set of components of the device 100 at normal power (step 201). If the eye-tracking sensor 101 determines that an eye-close event happened (step 202) then the eye-tracking sensor 101 broadcasts an eye-close-event message to the set of components of the device 100 (step 203), otherwise the set of components continues to operate at normal power (step 201) and periodically monitoring the eye for eye closure (step 202).

In response to receiving the eye-close-event message (step 203), the components of the set of components of the device 100 transition to operating at reduced power (step 204). If a return-to-normal condition occurs (step 205)—such as the expiration of a duration timer or the receipt of an eye-open-event message—then the components of the set of components return to operating at normal power (step 201), otherwise the components continue to operate at reduced power (step 204) and monitor for the occurrence of a return-to-normal condition (step 205).

As a result of running the above-described process, utilizing the above-described system, the system can reduce its operating power and reduce the likelihood that components of the system will reach thermal threshold temperatures that will require thermal mitigation. This, in turn, will enhance the user's experience. In addition, the reduced power usage may increase the battery lifetime for a battery-powered system.

Note that in some embodiments, if sufficient time has passed after a eye-close-event and no eye-open-event has occurred, then the device 100 may determine that the user has dozed off and, as a result, further reduce the power level of the components of the set of components. The device 100 may, in that case, also reduce the power of other components—for example, by dimming or powering down the display, or transitioning audio components into a low-power mode.

Although embodiments of the disclosure have been described where the visual-rendering device is part of a head-mounted display, the invention is not limited to head-mounted displays. In some alternative embodiments, the visual-rendering device is a mobile device that may be handheld or supported by a support mechanism or other visual-display device. Such devices may also similarly benefit from the above-described load reductions.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the invention can include a computer readable media embodying a method for operating an adaptive clock distribution system. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

1. An electronic visual-rendering device comprising:
an eye-tracking sensor configured to detect an eye-close event and, in response, output an eye-close-event message;
a first component configured to operate in at least a normal-power mode and a first low-power mode, wherein:
the first component is configured to transition from operating in the normal-power mode to operating in the first low-power mode in response to the eye-tracking sensor's output of the eye-close-event message.

2. The device of claim 1, wherein the component is configured to return to operating in the normal-power mode.

3. The device of claim 2, wherein the first component returns to operating in the normal-power mode after a predetermined time period.

4. The device of claim 3, wherein:
the eye-tracking sensor is configured to detect an eye-open event and, in response, output an eye-open-event message;
the predetermined time period is variable and is based on the time difference between a previous eye-open event and a previous eye-close event.

5. The device of claim 2, wherein:
the eye-tracking sensor is configured to detect an eye-open event and, in response, output an eye-open-event message; and
the first component returns to operating in the normal-power mode in response to the eye-tracking sensor's output of the eye-close-event message.

6. The device of claim 1, wherein:
the device is a head-mounted display further comprising:
orientation sensors configured to output sensor data; and
a sensor processor configured to:
receive the sensor data;
calculate corresponding orientation information based on the received sensor data;
output the corresponding orientation information;
operate in a normal-power mode;
receive the eye-close-event message; and
transition to operating in a low-power mode in response to receiving the eye-close-event message.

7. The device of claim 1, wherein the first component is any one of a central processing unit (CPU), a graphics processing unit (GPU), a hardware engine, and a display controller.

8. The device of claim 1, wherein:
the device further comprises one or more additional components;
each of the one or more additional components is configured to operate in at least a normal-power mode and a first low-power mode;
each of the one or more additional components is configured to transition from operating in the normal-power mode to operating in the first low-power mode in response to the eye-tracking sensor's output of the eye-close-event message.

9. The device of claim 1, further comprising a system-clock controller configured to lower a system-clock frequency in response to the output of the eye-close-event message.

10. The device of claim 9, further comprising a memory configured to operate at the system-clock frequency set by the system-clock controller.

11. A method for an electronic visual-rendering device, the method comprising:
detecting, by an eye-tracking sensor, an eye-close event;
outputting, by the eye-tracking sensor, an eye-close-event message in response to the detecting of the eye-close event;
operating a first component in a normal-power mode; and
transitioning the first component from operating in the normal-power mode to operating in a first low-power mode in response to the eye-tracking sensor outputting the eye-close-event message.

12. The method of claim 11, further comprising returning to operating the first component in the normal-power mode.

13. The method of claim 12, wherein the first component returns to operating in the normal-power mode after a predetermined time period.

14. The method of claim 13, further comprising:
detecting, by the eye-tracking sensor, an eye-open event; and
output, by the eye-tracking sensor, an eye-open-event message in response to the detecting of the eye-open event, wherein the predetermined time period is variable and is based on the time difference between a previous eye-open event and a previous eye-close event.

15. The method of claim 12, further comprising:
detecting, by the eye-tracking sensor, an eye-open event;
outputting an eye-open-event message in response to the detecting of the eye-open event; and
returning to operating the first component in the normal-power mode in response to the eye-tracking sensor outputting the eye-close-event message.

16. The method of claim 11, wherein the device is a head-mounted display further comprising orientation sensors configured to output sensor data and a sensor processor, the method further comprising:
receiving, by the sensor processor, the sensor data;
calculating, by the sensor processor, corresponding orientation information based on the received sensor data;
outputting, by the sensor processor, the corresponding orientation information;
operating the sensor processor in a normal-power mode;
receiving, by the sensor processor, the eye-close-event message; and
transitioning the sensor processor to operating in a low-power mode in response to receiving the eye-close-event message.

17. The method of claim 11, wherein the first component is any one of a central processing unit (CPU), a graphics processing unit (GPU), a hardware engine, and a display controller.

18. The method of claim 11, wherein the device further comprises one or more additional components, the method further comprising:
operating each of the one or more additional components in a normal-power mode;
transitioning each of the one or more additional components from operating in the normal-power mode to operating in a first low-power mode in response to the eye-tracking sensor outputting the eye-close-event message.

19. The method of claim 11, further comprising lowering, by a system-clock controller, a system-clock frequency in response to the output of the eye-close-event message.

20. The method of claim 19, further comprising operating a memory at the system-clock frequency set by the system-clock controller.

21. A system comprising:
means for electronic visual-rendering;
means for detecting an eye-close event;
means for outputting an eye-close-event message in response to detecting the eye-close event;
means for operating a first component in a normal-power mode; and
means for transitioning the first component from operating in the normal-power mode to operating in a first low-power mode in response to the outputting of the eye-close-event message.
